(19) United States
(12) Patent Application Publication
(10) Pub. No.: US 2004/0102115 A1
(43) Pub. Date: May 27, 2004

(54) Laminar reinforcing structure for impact resisting face on an article

(76) Inventor: Juan-Cheng Chou, Taichung (TW)

Correspondence Address: TROXELL LAW OFFICE PLLC, SUITE 1404, 5205 LEESBURG PIKE, FALLS CHURCH, VA, 22041, US

(21) Appl. No.: 10/304,765

(22) Filed: Nov. 27, 2002

(51) Int. Cl. B32B 5/12; B32B 5/02; B32B 27/04; B32B 27/12; B32B 1/00; B32B 3/00; D03D 15/00; D03D 25/00; B32B 25/02; B32B 25/10; B32B 5/16; B32B 9/00; B32B 15/02; B32B 17/02; B32B 19/00; B32B 21/02; B32B 23/02; B32B 27/02; B32B 9/04; B32B 27/00; B32B 27/40; B32B 17/06

(52) U.S. Cl. 442/134; 428/411.1; 428/407; 428/297.1; 428/297.4; 428/426; 428/423.7; 428/109; 428/113; 428/174; 428/902; 428/911

(57) ABSTRACT

A laminar reinforcing structure is provided for impact resisting face on an article, such as toe-puffs of safety shoes, striking faces on baseball bat and ice hockey stick, outsoles for boots of ice skates, and heads or faces of golf clubs, to increase an impact-resistant strength at such faces. The reinforcing structure includes a basic layer and at least one reinforcing layer. The basic layer is made of one or more plies of a fiber-reinforced thermosetting resin material and molded into a profile matching with that of the impact-resisting face of the article. The reinforcing layer is made of a thermoplastic resin-fiber woven fabric dip-coated with thermosetting resin to cover at least part of surfaces of the basic layer or be sandwiched between any two adjacent plies of the basic layer. The laminar reinforcing structure provides excellent mechanical strength and has low weight without substantially increasing the article weight.

### BACKGROUND OF THE INVENTION

The present invention relates to a laminar reinforcing structure for impact resisting face on an article, and more particularly to a low-weight reinforcing structure including a basic layer made of a fiber-reinforced thermosetting resin material and a reinforcing layer made of a thermoplastic-resin-fiber woven fabric dip-coated with a thermosetting resin material to provide excellent mechanical strength at an impact resisting face on an article.

There are a lot of articles frequently found in our daily life, such as safety shoes, baseball bats, ice hokey sticks, boots for ice skates, and golf clubs, that all include a normal impact face thereon. It would be desirable if a reinforcing structure could be attached to such impact face to effectively enhance the impact-resistant strength of the article at the impact face and accordingly the performance and usable life of the article without substantially increasing the weight or changing the shape thereof. For example, some part of workers in different industries must wear safety shoes with reinforced toe-puffs to protect their feet from possible injury due to impact or pressure by a heavy load. Most commercially available safety shoes have toe stiffeners made of a metal material, such as a steel plate, proved in the toe-puffs to support the same. While the steel-made toe stiffeners have excellent mechanical properties, including impact-resistant strength and pressure-resistant strength, they are heavy and tend to cause inconvenience to the wearers in their movements. In recent years, there are safety shoes with fiber-reinforced plastic toe-puffs introduced into markets to effectively improve the weight problem existed in the heavy metal toe stiffeners. However, the fiber-reinforced plastic toe-puffs have low mechanical strength, particularly the impact-resistant strength, which does not meet the standards set for required safety tests. The conventional reinforced toe-puffs or toe stiffeners for safety shoes are therefore not safe for use.

### SUMMARY OF THE INVENTION

A primary object of the present invention is to provide a laminar reinforcing structure for impact resisting face on an article to increase an impact-resistant strength at such face. The reinforcing structure includes a basic layer and at least one reinforcing layer. The basic layer is molded into a profile matching with that of impact-resisting face of the article, such as a toe-puff of safety shoes, and is made of one or more plies of a fiber-reinforced thermosetting resin material. The reinforcing layer is made of a thermoplastic-resin-fiber woven fabric dip-coated with a thermosetting resin material and covers at least part of surfaces of the basic layer. In the case of a multi-ply basic layer, an additional reinforcing layer is sandwiched between any two adjacent plies of the basic layer. The laminar reinforcing structure provides excellent mechanical strength and has low weight without adding any significant weight to the article.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a laminar toe stiffener for safety shoes according to a first preferred embodiment of the present invention;

FIG. 2 is a fragmentary and enlarged cross section taken along line 2-2 of FIG. 1;

FIG. 3 is a perspective view of a laminar toe stiffener for safety shoes according to a second preferred embodiment of the present invention;

FIG. 4 is a perspective view of a laminar toe stiffener for safety shoes according to a third preferred embodiment of the present invention;

FIG. 5 is a fragmentary and enlarged cross section taken along line 5-5 of FIG. 4 showing a first structure thereof; and

FIG. 5A is a fragmentary and enlarged cross section taken along line 5-5 of FIG. 4 showing a second structure thereof.

### DETAILED DESCRIPTION OF THE PREFERRED EMBODIMENTS

The present invention relates to a laminar reinforcing structure for impact-resisting face on an article. The laminar reinforcing structure provides enhanced impact-resistant strength and occupies only very small volume to enable application of it to normal impact faces on various articles, such as toe-puffs of safety shoes, striking faces on baseball bats and ice hockey sticks, outsoles for ice skate boots, and head faces of golf clubs. The application of the laminar reinforcing structure of the present invention to the impact faces of these articles does not change an inherent profile of such impact faces. In other words, the laminar reinforcing structure of the present invention includes a basic layer that is molded during manufacturing into a profile completely matching with a configuration of the impact-resisting face of the article to be reinforced. For example, the basic layer of the laminar reinforcing structure of the present invention can be molded into a toe-puff shape for use on safety shoes.

While the laminar reinforcing structure of the present invention may appear in various forms, it will now be described based on a toe stiffener for use at the toe-puff of safety shoes as an example. The toe stiffener is located at the toe-puff that is a portion on safety shoes to provide necessary high impact-resistance or pressure-resistance. More specifically, the toe stiffener is set between inner and outer layers of the toe-puff during manufacturing of safety shoes to function as a protective means with strengthened structure.

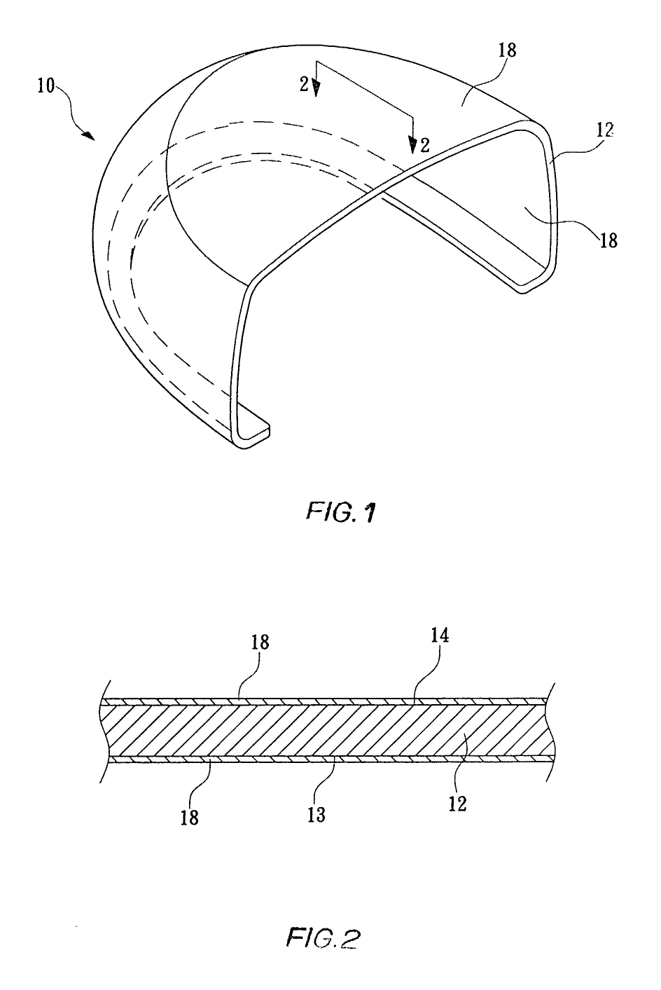

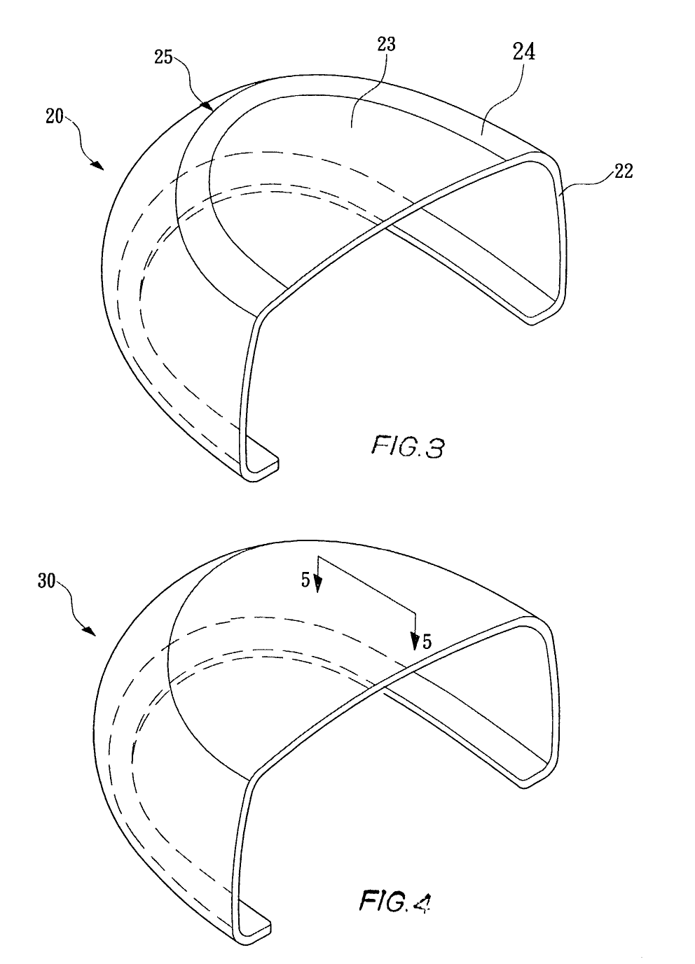

Please refer to FIGS. 1 and 2 in which a toe stiffener 10 for a toe-puff of safety shoes according to a first preferred embodiment of the present invention is shown. The toe stiffener 10 includes a basic layer 12 and reinforcing layers 18 separately attached to inner and outer surfaces 13, 14 of the basic layer 12, such that the basic layer 12 is sandwiched between the reinforcing layers 18. The basic layer 12 is in the shape of a toe-puff for fitting to the toe-puff of safety shoes, and is made of a fiber-reinforced thermosetting resin material. The reinforcing fiber used for the purpose of the present invention depends on actual requirements and may include, but not limited to, glass fiber, carbon fiber, boron fiber, and aromatic polyamide fiber or the so-called Kevlar fiber, which all are continuous fibers. The thermosetting resin used for the purpose of the present invention may include, but not limited to, epoxy resin, phenol resin, etc. The reinforcing layer 18 is made by way of dip-coating a thermoplastic resin-fiber woven fabric with a thermosetting resin material. Fibers for making the thermoplastic resin-fiber woven fabric may include, but not limited to, nylon fiber and polyester fiber (PET fiber), which preferably have a melting point within the range from 160° C. to 260° C. Moreover, it is preferable yarns of the fiber-woven fabric used for the purpose of the present invention are of the grades from 900 to 4800 deniers.

With the reinforcing layer 18 having the above-described structure, the toe stiffener 10 has effectively enhanced mechanical properties, particularly a largely improved impact-resistant strength. Tests conducted on full-scale samples prove the toe stiffener 10 indeed has mechanical properties far beyond standards set for various safety tests. In brief, the toe stiffener 10 of the present invention is not only absolutely safe for use but also much lighter than the conventional steel toe stiffener to effectively eliminate drawbacks existed in the toe stiffeners of prior art.

In manufacturing the toe stiffener 10, the basic layer 12 and the reinforcing layers 18 are not necessarily set or positioned in the manner defined in the first preferred embodiment as shown in FIGS. 1 and 2. They could also be arranged in other various manners. For example, the reinforcing layer 18 may be attached to only one of the inner and outer surfaces 13, 14 of the basic layer 12. FIG. 3 shows a toe stiffener 20 according to a second preferred embodiment of the present invention including a basic layer 22 and a reinforcing layer 24 attached to an outer surface 23 of the basic layer 22. It is noted the reinforcing layer 24 attached to the outer surface 23 covers only an upper front edge 25 of the toe stiffener 20, at where the toe stiffener 20 bends to cause a lower mechanical strength and needs special reinforcement to meet the basic safety requirement in use.

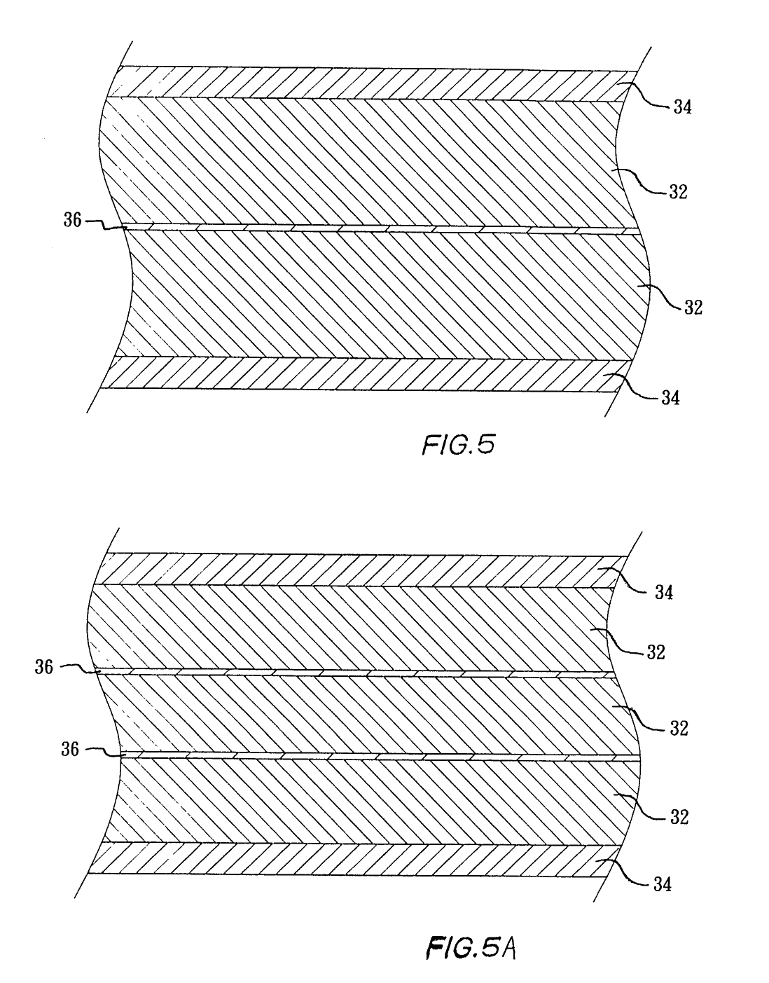

FIG. 4 shows a toe stiffener 30 according to a third preferred embodiment of the present invention including more than one basic layer 32 and more than one reinforcing layer 34. In a first example of the toe stiffener 30, a fragmentary and enlarged cross section of which taken along line 5-5 of FIG. 4 is shown in FIG. 5, there is included two laminated basic layers 32 and two reinforcing layers 34 separately attached to outer surfaces of the two basic layers 32. In a second example of the toe stiffener 30, a fragmentary and enlarged cross section of which taken along line 5-5 of FIG. 4 is shown in FIG. 5A, there is included three laminated basic layers 32 and two reinforcing layers 34 separately attached to outer surfaces of the two outermost basic layers 32. Again, the basic layers 32 are made of a fiber-reinforced thermosetting resin. Moreover, a layer of non-woven cloth made of thermoplastic fibers may be further sandwiched between any two adjacent basic layers 32 to serve as an additional reinforcing layer 36. It is preferable the non-woven cloth used for the purpose of the additional reinforcing layer 36 of the present invention has a bulk weight of 10 g to 100 g per square meter.

As a matter of fact, the numbers of the basic layer and the reinforcing layer of the toe stiffener of the present invention, and the positions and manners for binding the two types of layers may be varied, so long as enhanced mechanical properties, including the impact-resistant strength, of the toe stiffener can be obtained. For example, the reinforcing layer or layers may be provided at the upper front portion of the toe-puff of the safety shoes to locate at one or two of the innermost and the outermost surface of the basic layer or layers, or between any two adjacent basic layers, or even at different and particularly selected positions on the surfaces of the basic layers. The number of reinforcing layers for the different positions on the basic layers may be selectively changed, too. All these changes should be considered as equivalents of the present invention. While the present invention has been described with some preferred embodiments thereof, it is understood that many changes and modifications in the described embodiments can be carried out by those who have ordinary skills in the art without departing from the scope and the spirit of the invention as defined by the appended claims.

Both the basic layer and the reinforcing layer for the purpose of the present invention are of a laminar structure that, after being laminated in different manners to form an integral reinforcing structure, provides an excellent mechanical strength, occupies an extremely small space, and has a low weight, making the reinforcing structure suitable for use on the impact-resisting faces of various articles, such as baseball bats, ice hockey sticks, outsoles for boots of ice skates, heads for golf clubs, etc. The reinforcing structure of the present invention may be incorporated into the articles at the impact-resisting faces during manufacturing of the articles, so that such impact resisting faces have the required impact-resistant strength for the various articles to have enhanced performance and prolonged usable life. The present invention has been tested and proven to meet or pass the required safety standards. Test reports evidencing and supporting the safe use of the toe stiffener according to the present invention may be provided on request.

What is claimed is:

1. A laminar reinforcing structure for impact resisting face on an article, comprising a basic layer and at least one reinforcing layer;
said basic layer being a lamina molded into a profile matching with that of said impact resisting face of said article, and being made of a fiber-reinforced thermosetting resin material; and
said reinforcing layer being made of a thermoplastic resin-fiber woven fabric dip-coated with a thermosetting resin material, and being attached to said basic layer;
whereby said laminar reinforcing structure is capable of enhancing mechanical properties of said impact resisting face of said article while having a low weight that does not significantly add any weight to said article or change an appearance of said article.

2. The laminar reinforcing structure for impact resisting face on an article as claimed in claim 1, wherein said reinforcing layer covers at least part of surfaces of said basic layer.

3. The laminar reinforcing structure for impact resisting face on an article as claimed in claim 2, wherein said reinforcing layer covers an outer surface of said basic layer.

4. The laminar reinforcing structure for impact resisting face on an article as claimed in claim 2, wherein said reinforcing layer covers an inner surface of said basic layer.

5. The laminar reinforcing structure for impact resisting face on an article as claimed in claim 2, wherein said reinforcing layer covers both inner and outer surfaces of said basic layer.

6. The laminar reinforcing structure for impact resisting face on an article as claimed in claim 1, wherein said basic layer includes more than one ply of said fiber-reinforced thermosetting resin material, and wherein said reinforcing layer is sandwiched between any two adjacent plies of said fiber-reinforced thermosetting resin material.

7. The laminar reinforcing structure for impact resisting face on an article as claimed in claim 1, wherein said fiber-reinforced thermosetting resin material for making said basic layer includes reinforcing fibers selected from the group consisting of glass fiber, carbon fiber, boron fiber, and aromatic polyamide fiber or Kevlar fiber.

8. The laminar reinforcing structure for impact resisting face on an article as claimed in claim 7, wherein said reinforcing fibers included in said fiber-reinforced thermosetting resin material are continuous fibers.

9. The laminar reinforcing structure for impact resisting face on an article as claimed in claim 1, wherein said thermoplastic resin-fiber woven fabric for making said reinforcing layer is selected from the group consisting of nylon and polyester fiber or PET fiber.

10. The laminar reinforcing structure for impact resisting face on an article as claimed in claim 1, wherein said thermoplastic resin fiber for weaving into said fabric for making said reinforcing layer preferably has a melting point within the range from 160° C. to 260° C.

11. The laminar reinforcing structure for impact resisting face on an article as claimed in claim 1, wherein said thermoplastic resin-fiber woven fabric for making said reinforcing layer is preferably of 900 to 4800 deniers.

12. The laminar reinforcing structure for impact resisting face on an article as claimed in claim 6, wherein said reinforcing layer sandwiched between any two plies of said fiber-reinforced thermosetting resin material of said basic layer includes a thermoplastic resin-fiber non-woven cloth dip-coated with a thermosetting resin material, and said thermoplastic resin-fiber non-woven cloth preferably having a bulk weight of 10 to 100 g per square meter.
